(19) United States
(12) Patent Application Publication
(10) Pub. No.: US 2010/0228961 A1
(43) Pub. Date: Sep. 9, 2010

(54) HIERARCHICAL SECURE NETWORKS

(75) Inventors: John Arley Burns, Houston, TX (US); Edward J. Blevins, Austin, TX (US)

Correspondence Address: CONLEY ROSE, P.C.;David A. Rose, P. O. BOX 3267, HOUSTON, TX, 77253-3267, US

(73) Assignee: ERF WIRELESS, INC., League City, TX (US)

(21) Appl. No.: 12/396,608

(22) Filed: Mar. 3, 2009

(51) Int. Cl. H04L 9/00; H04L 12/56; G06F 15/177

(52) U.S. Cl. 713/150; 370/401; 709/220

(57) ABSTRACT

Systems and methods for creating hierarchical network communications between trusted domains are described herein. An illustrative system includes a first, second, and third network. The first and second networks each include a plurality of routers, each router capable of establishing a secure data path with another router in the respective network. The third network includes a first router and a second router, each router capable of establishing a secure data path with the other router. The definition of each secure data path is provided by an external storage device that detachably couples to a router. The storage devices defining the secure data paths are unique to each router. The first and second networks communicate through the third network.

### RELATED APPLICATIONS

This application contains subject matter that may be related to U.S. Nonprovisional application Ser. No. 11/533,652, filed Sep. 20, 2006 and entitled “Router for Use in a Monitored Network,” to U.S. Nonprovisional application Ser. No. 11/533,672, filed Sep. 20, 2006 and entitled “Monitoring Server For Monitoring A Network Of Routers,” to U.S. Nonprovisional application Ser. No. 11/689,712, filed Mar. 22, 2007 and entitled “Safeguarding Router Configuration Data,” and to U.S. Nonprovisional application Ser. No. 11/777,704, filed Jul. 13, 2007 and entitled “Separate Secure Networks Over a Non-Secure Network” all of which are herein incorporated by reference.

### BACKGROUND

Routers are electrical devices that are used to permit computers and networks of computers to pass data back and forth. A router typically has one or more input ports and one or more output ports. Data packets containing a destination address arrive on an input port. Based on the destination address, the router forwards the data packet to an appropriate output port which may be connected to the destination computer system or to another router. The data being transmitted between routers may be confidential (e.g., bank account data in the context of a bank's network) and thus the security of such data should be ensured. Accordingly, at least some routers provide encryption to allow secure communications across an untrusted communication channel, such as the Internet.

Additionally, some such routers provide additional security to protect the configuration of the routers themselves, but such configuration protection measures sometimes operate on the presumption that a person or group of persons authorized to configure the router is/are authorized to control all data traffic through the router. Thus, for security reasons such a router may only be used to route data to or from a limited number of destinations and sources that are all under the control of the authorized person or group. If additional data to or from other destinations and sources is needed, additional routers must be added to such a network, thereby incurring a corresponding increase in installation and maintenance costs, as well as complexity. Thus, an ability to securely connect secure networks of manageable size while maintaining a capability to individually reconfigure each network is desirable.

### SUMMARY

Systems and methods for creating hierarchical network communications between trusted domains are described herein. In accordance with at least some embodiments, a system includes a first, second, and third network. The first network includes a first set of routers. Each router of the first set is capable of establishing a secure data path with another router of the first set. The definition of each secure data path is provided by a first set of external storage devices that detachably couple to each router of the first set. Each storage device of the first set defining a secure data path is unique to a router of the first set.

The second network includes a second set of routers. Each router of the second set is capable of establishing a secure data path with another router of the second set. The definition of each secure data path is provided by a second set of external storage devices that detachably couple to each router of the second set. Each storage device of the second set defining a secure data path is unique to a router of the second set.

The third network includes a first router and a second router. Each router is capable of establishing a secure data path with the other router in the third network. The definition of the secure data path is provided by a third set of external storage devices that detachably couples to the first and second routers. Each storage device of the third set defining the secure data path is unique to each of the first and second routers.

In other embodiments, a method includes creating a third trust domain. The third trust domain includes a hierarchical router of a first trust domain and a hierarchical router of a second trust domain. Each router of the third trust domain is configured by detachably coupling an external storage device to the router. Each external storage device contains data for configuring only a single selected router. Data is transferred between the first and second trust domains via the third trust domain.

In yet other embodiments, a system includes a plurality of secure networks and a storage device. The storage device includes data for configuring a router of a first secure network to communicate with a router of a second secure network via a third secure network. The storage device is external to and capable of being detachably coupled to a router. The data is applicable to only a single selected router.

### BRIEF DESCRIPTION OF THE DRAWINGS

For a detailed description of the illustrative embodiments of the invention, reference will now be made to the accompanying drawings in which:

FIG. 1 shows a network routing system utilizing a router constructed in accordance with at least some illustrative embodiments;

FIG. 2 shows a configuration device and a maintenance device, both coupled to a router constructed in accordance with at least some illustrative embodiments;

FIG. 3 shows a system including a plurality of trust domains wherein a first trust domain communicates with a second trust domain via a third trust domain in accordance with various embodiments; and

FIG. 4 shows a flow diagram for a method for providing secure connection of a first trust domain to a second trust domain in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

Additionally, the term “system” refers to a collection of two or more hardware and/or software components, and may be used to refer to an electronic device, such as a computer, a network router, a portion of a computer or a network router, a combination of computers and/or network routers, etc. Further, the term “software” includes any executable code capable of running on a processor, regardless of the media used to store the software. Thus, code stored in non-volatile memory, and sometimes referred to as “embedded firmware,” is included within the definition of software. Also, the term “secure,” within the context of secure data, indicates that data has been protected so that access by unauthorized personnel is either prevented, or made sufficiently difficult such that breaching the protection measures is rendered impractical or prohibitively expensive relative to the value of the data.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

Routers are sometimes used as transfer points between secured and unsecured networks. When so utilized, the routers may be configured to protect data originating from, or destined for, a secure network and/or device. Such protection may include encryption of the data prior to transmission across an unsecured network (e.g., IPSec, RSA Public/Private Key Encryption, and Virtual Private Networks) as well as secure and/or encrypted authentication of a router on one end of the transaction by the router at the other end of the transaction (e.g., digital signatures). Because the configuration of these routers is a key element to ensuring data security, it is important to secure and control access to the configuration data of such routers. Embodiments of the present disclosure provide such security by requiring physical access to each router in a network through a detachable configuration device. However, as the number of routers in a network increases, it becomes burdensome to require a visit to each router for reconfiguration with each network change. Embodiments disclosed herein relieve the burden of reconfiguration by allowing connection of multiple trust domains in a hierarchical network while maintaining the security features mentioned above as to each trust domain.

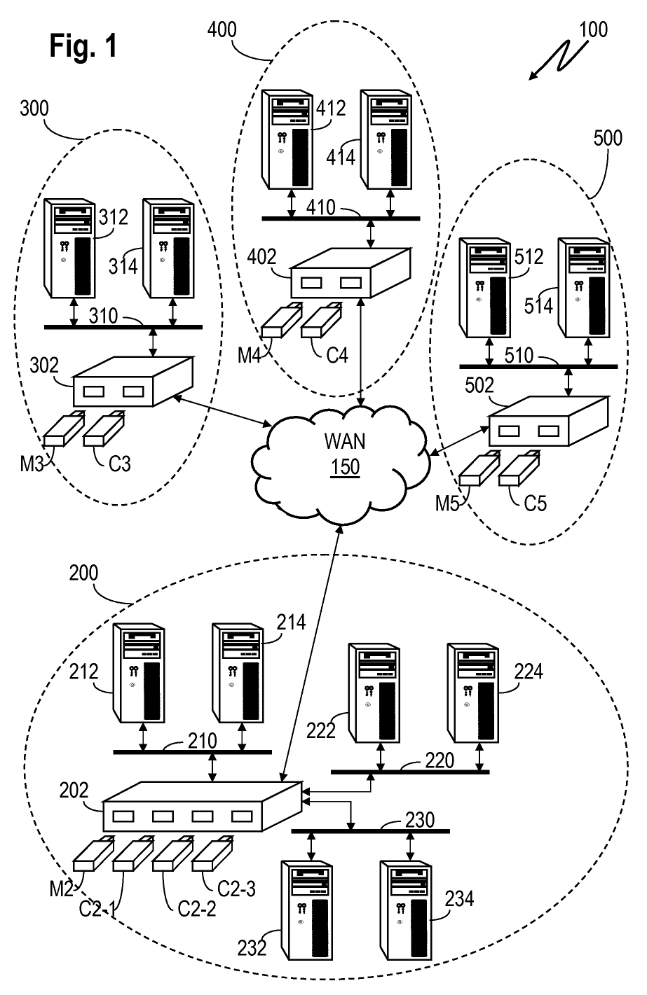

FIG. 1 shows a networked system 100 that incorporates a router 202, constructed in accordance with at least some illustrative embodiments, that provides the distributed configuration control described above. Although the illustrative embodiment shown and described includes a network router, other illustrative embodiments may include different or additional devices, such as network switches and/or hubs, and all such devices are within the scope of the present disclosure. Four sub-networks (200, 300, 400 and 500) are shown that couple to each other via wide area network (WAN) 150. A WAN 150 as defined herein comprises any network and network technology used to connect local area networks. Each sub-network comprises a router (202, 302, 402 and 502 respectively) that provides connectivity between WAN 150 and one or more local area networks (LANs) coupled to each router. The LANs within each sub-network (LANs 210, 220, 230, 310, 410 and 510) couple one or more computer systems (212, 214, 222, 224, 232, 234, 312, 314, 412, 414, 512 and 514) to the router corresponding to a given sub-network, thus providing each computer system on each LAN connectivity to WAN 150 and to each of the other computer systems on each LAN.

Each router isolates the LANs to which the router couples from WAN 150 and other LANs by controlling and verifying where data is allowed to be sent and received, and by encrypting data before it is transmitted across WAN 150. For example, if a user wishes to transmit secure data from computer system 212 on LAN 210 to computer system 514 on LAN 510, router 202 is configured to allow the specific type and security level of data to be transmitted from computer system 212 to computer system 514 by the user attempting to send the data. Router 202 establishes a connection with router 502 and sets up a “tunnel” or secure data path through WAN 150 wherein the contents of the packets, including the network protocol headers of the messages as received from the respective LANs, are encrypted and encapsulated according to the networking protocol of WAN 150 (e.g., TCP/IP and IPsec). In this manner the data being transmitted (and its LAN headers) appears in clear text form only on the source and destination LANs, and is otherwise visible on all other intervening networks only in encrypted form.

The security of the “tunneled” data (encrypted, encapsulated and transmitted across WAN 150) depends significantly on the security of the configuration of each of the routers. In at least some illustrative embodiments, each router of FIG. 1 protects its configuration through the use of an external, detachable maintenance device (M2, M3, M4 and M5), and/or one or more external, detachable configuration devices (C2-1, C2-2, C2-3, C3, C4 and C5), each of which may be under the control of a separate user. Each separate user and each external device may be authenticated by the router to which the devices couple before the configuration of the router can be loaded and/or modified. In at least some illustrative embodiments, the devices are non-volatile storage devices that couple to the routers via Universal Serial Bus (USB) style connectors.

As can be seen in the illustrative embodiment of FIG. 1, routers 302, 402 and 502 each utilize a single maintenance device (M3, M4 and M5) and a single configuration device (C3, C4 and C5) to configure each router. Each device may be under the control of separate individuals or organizations, and each device as well as each user of each device may be authenticated by the router. As a result, in at least some illustrative embodiments a minimum of two individual users are required to alter the configuration of a router. Additional individuals or organizations may be assigned physical control of each configuration device (i.e., custodians of the devices), further enhancing security and discouraging collusion among malicious users. Upon initialization or reconfiguration of the router, each device coupled to the router may be authenticated by decrypting encrypted identification data stored on the device, using an embedded decryption key stored within the router. Each user of each device may be authenticated by comparing authentication data provided by a user against reference authentication data stored either within the router or within the device presented by the user. The authentication data may be provided by the user in the form of a user ID and password entered via a keyboard and/or mouse coupled to the router, or in the form of biometric data, such as a fingerprint provided via an appropriate scanning device coupled to the router. Other mechanisms for providing user authentication data will become apparent those of ordinary skill in the art, and all such mechanisms are within the scope of the present disclosure.

Continuing to refer to FIG. 1, router 202 utilizes maintenance and configuration devices similar to those used by the other routers, but is capable of accepting multiple configuration devices. Each configuration device (C2-1, C2-2 and C2-3) is capable of configuring router 202 to route data and to connect to source and destination computer systems preferably controlled of specific individuals and/or organizations, each of which control access to each configuration device, and each of which preferably must provide separate authentication data for their corresponding device. By providing separate configuration data, router 202 may be configured to provide multiple secure data paths, each under the configuration control of a separate individual and/or organization. Thus, for example, router 202 can establish a first tunnel between router 202 and router 502 to route data securely from computer system 212 to computer system 512. While the first tunnel is operative, router 202 can establish a second, separate tunnel between router 202 and router 302 to route data from computer system 224 to computer system 312. Those of ordinary skill in the art will recognize that any number of such tunnels can be established by router 202.

The configuration allowing the first tunnel to be setup and used may be controlled by a first authorized user (e.g., a financial officer of a first bank) and used to route one type of data (e.g., confidential financial data), while the configuration allowing the second tunnel to be setup and used may be controlled by a second authorized user (e.g., a network engineer) and used to route the same or different type of data (e.g., network monitoring data). Each tunnel is allowed and setup based upon configuration data provided by a corresponding configuration device, presented to the router alone or in conjunction with the maintenance device, and loaded into volatile storage within the router as part of the router's configuration. Thus, for example, configuration device C2-1 provides the configuration data and/or at least some of the authentication data related to routing data from computer system 212 to computer system 512 via one tunnel, while configuration device C2-3 provides the configuration and/or authentication data related to routing data from computer system 224 to computer system 312 via another tunnel.

Although the above example divides the configuration stored in each configuration device based upon destination address of the computer systems and/or networks, other divisions are possible. Tunnels may be established based upon the type of data being transferred (e.g., financial data, network monitoring data, and camera and alarm data), and/or based upon who controls access to the data (e.g., a bank official, a security officer, or network maintenance personnel). For example, data provided by computer system 212 may include financial data from one bank that is being sent to computer system 414 at another bank. At the same time, the first bank may also provide video surveillance data from its security computer system to local police departments on an “as needed” basis if an alarm is detected.

Banking regulations generally do not allow any external, non-banking entities, such as a police department, to connect directly to a bank's network 210, due to the presence of confidential banking data on network 210. Router 202 provides a separate, secure tunnel through which only the video surveillance data is routed to such an external entity without giving the entity direct access to network 210, and without compromising confidential banking data. The tunnel is encrypted using different keys than the banking data, and is routed to a computer system operated by the police department (e.g., computer system 514) based upon rules that allow only this type of data to be routed to the police department's computer system. These rules may be stored on a separate configuration device, under the control of a person authorized to configure the routing of the video surveillance data, but not the financial data. As a result, the police department does not gain access to the banking data, the decryption keys used to decrypt the video surveillance data cannot be used to decrypt the banking data even if the police department did gain access to the financial data, and the person authorized to use the surveillance configuration device cannot alter the configuration of router 202 to gain access or decrypt banking data present on network 210.

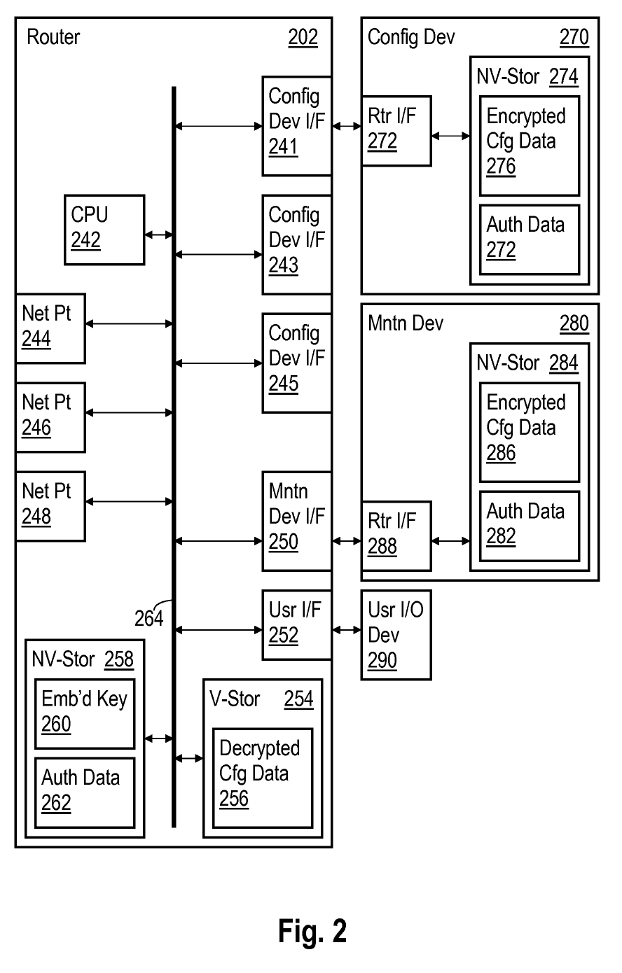

FIG. 2 shows a block diagram that details a router 202, constructed in accordance with at least some illustrative embodiments, and further details a configuration device 270 and a maintenance device 280, both coupled to router 202. Router 202 includes central processing unit (CPU) 242, network ports (Net Pts) 244, 246 and 248, configuration device interfaces (Config Dev I/Fs) 241, 243 and 245, maintenance device interface (Mntn I/F) 250, user interface (Usr I/F) 252, volatile storage (V-Stor) 254, and non-volatile storage (NV-Stor) 258, each of which couple to a common bus 264. CPU 242 controls the routing of data between network ports 244, 246 and 248, based on decrypted configuration data (Decrypted Cfg Data) 256 stored within volatile storage 254. The configuration data is stored in encrypted form within configuration device (Config Dev) 270, which detachably couples to router 202 via configuration device interface 241. Configuration device 270 includes router interface (Rtr I/F) 272 and non-volatile storage 274, each coupled to the other. Non-volatile storage 274 stores encrypted configuration data (Encrypted Cfg Data) 276, which is retrieved by CPU 242 of router 202 while configuration device 270 is coupled to configuration device interface 241. CPU 242 uses embedded key (Emb'd Key) 260, stored within non-volatile storage 258, to decrypt the encrypted configuration data 276 to produce at least some of decrypted configuration data 256.

Maintenance device 280 includes router interface (Rtr I/F) 288 and non-volatile storage 284, each coupled to the other. Non-volatile storage 284 stores additional encrypted configuration data (Encrypted Cfg Data) 286, which is retrieved by CPU 242 of router 202 while maintenance device 280 is coupled to maintenance device interface 250. CPU 242 uses embedded key (Emb'd Key) 260, stored within non-volatile storage 258, to decrypt the additional encrypted configuration data 286 to optionally produce at least some of decrypted configuration data 256. Maintenance device 280 is not required for normal operation of the router (“normal mode”), but is instead used to place the router into a “maintenance mode,” wherein authorized maintenance personnel can perform scheduled maintenance of the router, and/or troubleshoot problems with the router and network.

Access to the embedded key 260, and thus to the configuration data required to operate the router 202 may be controlled through the use of user-provided authentication data. In at least some illustrative embodiments, the authentication data is provided by a user operating user input/output device (Usr I/O Dev) 290, which is coupled to user interface 252. The input provided by the user may be in the form of a password, or in the form of biometric data (e.g., scanned fingerprint or retina data). The authentication data may then be compared to stored and/or encrypted reference copies of the authentication data, which may be stored locally within router 202 in non-volatile storage 258 (Auth Data 262), externally in non-volatile storage 274 within configuration device 270 (Auth Data 272), and/or externally in non-volatile storage 284 within maintenance device 280 (Auth Data 282).

It should be noted that although the illustrative embodiment of FIG. 2 does not show additional configuration devices coupled to configuration device interfaces 243 and 245, any number of configuration devices, up to the number of available configuration device interfaces, may be coupled to router 202. Decrypted configuration data 256, stored in volatile storage 254, results from decrypting and combining the encrypted configuration data stored in each configuration device (and optionally the maintenance device) coupled to router 202. Other illustrative embodiments may include any number of configuration device interfaces. Also, software executing on CPU 242 may allow multiple configuration devices to be sequentially plugged into, authenticated, and unplugged from a single configuration device interface, extending the number of configuration devices that may be used to configure the router beyond the number of available configuration device interface. Other techniques and configurations for increasing the number of configuration devices that may be used to configure router 202 will become apparent to those of ordinary skill in the art, and all such techniques and configurations are within the scope of the present disclosure.

An issue arising in the implementation of the network routing system 100 pertains to the number of routers in the system. As described above, each router (e.g., router 202) establishes a connection with another router (e.g., router 502) and sets up a “tunnel” or secure data path for data transfers between the routers. The configuration of the routers (i.e., the setup of the tunnels) is protected through the use of one or more external, detachable configuration devices. In order to add or remove a router, or to modify a router's configuration, a configuration device applicable to each router must be modified, and attached to the router to enable router reconfiguration. Requiring attachment of a configuration device to each router is advantageous in that configuration access to the router is restricted and addition of a router without physical access to each connecting router is prohibited. Thus, no changes can be made to a fully meshed network without attaching a configuration device to each router. However, as the number of routers in the system 100 increases (e.g., >50) requiring physical access to each router each time a router is added, removed, or reconfigured becomes burdensome.

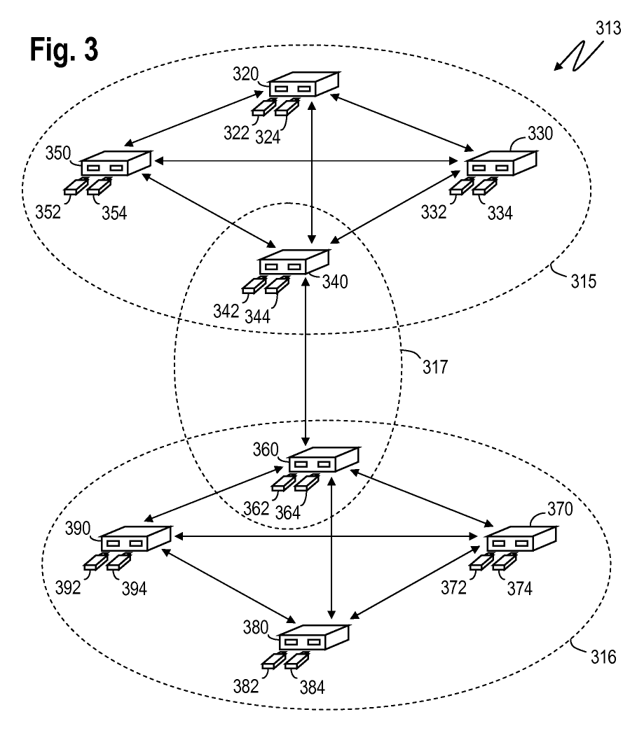

FIG. 3 shows a system 313 including a plurality of trust domains 315, 316, 317 wherein a first trust domain 315 communicates with a second trust domain 316 via a third trust domain 317 in accordance with various embodiments. A “trust domain” as used herein refers to a network of securely interconnected trusted routers (i.e., routers comprising the security features described supra). The first trust domain 315 comprises a set of routers 320, 330, 340, 350. Each router 320, 330, 340, 350 comprises the security features described above in regard to, for example, the router 202. The routers 320, 330, 340, 350 are interconnected to form an isolated and secure network (e.g., system 100). Accordingly, each router 320, 330, 340, 350 is configured to communicate only with other routers 320, 330, 340, 350 in the first trust domain 315. Each router 320, 330, 340, 350 can include the information required to communicate with every other router in the trust domain 315. The second trust domain 316 similarly includes a set of routers 360, 370, 380, 390 each including features as described for router 202, and configured to communicate only with routers 360, 370, 380, 390 in the second trust domain 316.

From each of the first trust domain 315 and the second trust domain 316, embodiments select a router through which communications with other secure networks (i.e., trust domains) is to be allowed. The selected routers are designated hierarchical trusted routers. In FIG. 3, router 340 is selected to serve as the hierarchical router for trust domain 315, and router 360 is selected to serve as the hierarchical router for trust domain 316. To enable the selected routers 340, 360 to serve in the hierarchical capacity, the routers 340, 360 are reconfigured by attachment of a configuration device 344, 364. Some embodiments may require attachment of a maintenance device 342, 362 in addition to the configuration device 344, 364 to further enhance security. In the first trust domain 315, routers 320, 330, 350 are reconfigured by attachment of a configuration device 324, 334, 354 to allow router 340 to serve as a hierarchical router for the trust domain 315. Some embodiments may require attachment of a maintenance device 322, 332, 352 in addition to the configuration device 324, 334, 354 to further enhance security. Similarly, in the second trust domain 316, routers 370, 380, 390 are reconfigured by attachment of a configuration device 374, 384, 394 to allow router 360 to serve as a hierarchical router for the trust domain 316. As an additional security measure, some embodiments may require attachment of a maintenance device 372, 382, 392 in addition to the configuration device 324, 334, 354.

To establish a connection between trust domains 315 and 316, embodiments create a third trust domain 317. The third trust domain 317 comprises the selected hierarchical routers 340, 360 of trust domains 315 and 316. Thus, communication between the routers 340, 360 is enabled in the third trust domain 317, again by attachment of a configuration device 344, 364. Moreover, because each other router 320, 330, 350 in the first trust domain 315 and each other router 370, 380, 390 in the second trust domain 317 was reconfigured to allow routers 340, 360 to serve as hierarchical routers for the trust domains 315, 316, communication between routers in trust domains 315, 316 is enabled. For example, router 350 can communicate with router 390 through routers 340 and 360. Thus, embodiments of the system 313 provide manageability of the trust domains 315, 316 by providing for interconnection of trust domain 315 and trust domain 316 by a third trust domain 317, wherein trust domain 317 comprises a router 340, 360 in each of trust domains 315 and 316. Embodiments allow any number of trust domains to be interconnected at a hierarchical level. Moreover, embodiments provide for extension of the hierarchy by selecting a router at an upper level of the hierarchy to serve as a hierarchical router connecting to a higher level trust domain. For example, router 340 may be selected to serve as a hierarchical router for trust domain 317 and connected to a higher level trust domain (not shown).

Embodiments of the system 313 enable secure connection of a large number of routers, wherein all the routers in the network are made secure using the features described herein, for example with regard to router 202 and associated configuration device C2 and management device M2. Moreover, embodiments of system 313 provide the efficiency of direct connection mesh networks with the scalability of hierarchical networks, allowing entities to divide their secure network into trust domains regardless of physical network layout. Embodiments reduce the burden of maintaining network security by creating trust domains that can be individually managed within a larger secure network.

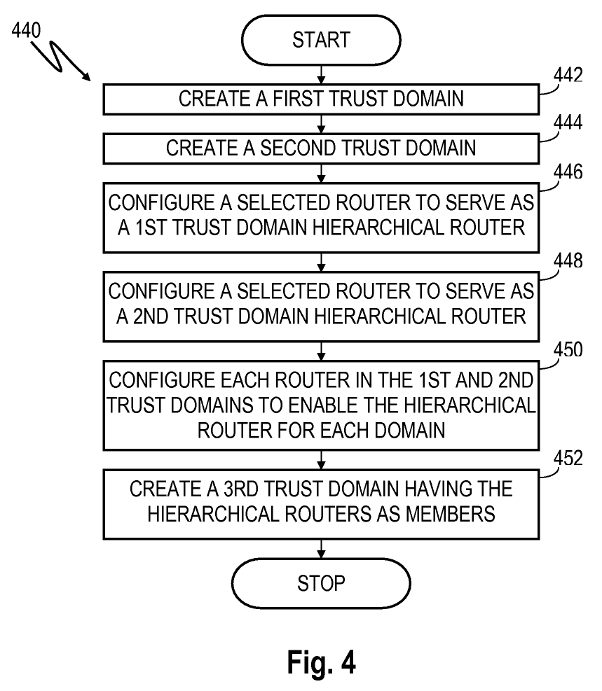

FIG. 4 shows a flow diagram 440 for a method for providing secure connection of a first trust domain to a second trust domain in accordance with various embodiments. In block 442, a first trust domain 315 is created. The trust domain 315 comprises a fully-meshed network of trusted routers. No change to the mesh configuration of the trust domain can be made without attaching a configuration device to each router in the trust domain and updating the router's configuration. Communications within this domain are allowed only between trusted routers. Each trusted router includes the information required to each communicate securely with each other router in the network. Sans embodiments of the present disclosure, no communications are allowed between routers within domain 315 and routers without domain 315.

A second trust domain 316 is created in block 444. Trust domain 316 uses different encryption/decryption keys than trust domain 315. As above, sans embodiments of the present disclosure, each router in trust domain 316 can communicate with other routers in trust domain 316, but with no routers outside trust domain 316.

In block 446, a router 340 is selected to serve as the hierarchical router for trust domain 315. The hierarchical router 340 permits routers within trust domain 315 to communicate with other trusted networks (e.g., trust domain 316). Similarly, in block 448, a router 360 is selected to serve as the hierarchical router for trust domain 316. Appropriate configuration devices 344, 364 are attached to the selected routers 340, 360 to reconfigure the routers 340, 360 to function as hierarchical routers for each trust domain 315, 316.

The routers 320, 330, 350 of trust domain 315 are reconfigured, in block 450, by attachment of a configuration device 324, 334, 354 to enable router 340 as the hierarchical router for the trust domain 315. Similarly, the routers 370, 380, 390 of trust domain 316 are reconfigured by attachment of a configuration device 374, 384, 394 to enable router 360 as the hierarchical router for the trust domain 316.

Finally, to establish a connection between trust domain 315 and trust domain 316, in block 452, a third trust domain 317 is created. Routers 340 and 360 are included as members of trust domain 317. A secure data path between routers, allowing direct communication between routers 340 and 360 is defined by attachment of appropriate configuration devices to the routers 340, 360. Moreover, because each router 320, 330, 350 in trust domain 315 has been configured to recognize router 340 as a hierarchical router, and each router 370, 380, 390 in trust domain 316 has been configured to recognize router 360 as a hierarchical router, communication between any router in the trust domains 315, 316 is permitted.

Thus, embodiments of the present disclosure allow for secure interconnection of trust domains of manageable size. The routers of each trust domain may be reconfigured with no requirement to reconfigure the routers of other coupled trust domains.

The above disclosure is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a first network comprising a first set of routers, each router of the first set is capable of establishing a secure data path with another router of the first set, the definition of each secure data path is provided by a first set of external storage devices that detachably couple to each router of the first set, wherein each storage device of the first set defining a secure data path is unique to a router of the first set;
a second network comprising a second set of routers, each router of the second set is capable of establishing a secure data path with another router of the second set, the definition of each secure data path is provided by a second set of external storage devices that detachably couple to each router of the second set, wherein each storage device of the second set defining a secure data path is unique to a router of the second set;
a third network comprising a first router and a second router each router capable of establishing a secure data path with the other router in the third network, the definition of the secure data path provided by a third set of external storage devices that detachably couples to the first and second routers, wherein each storage device of the third set defining the secure data path is unique to each of the first and second routers;
wherein the first and second networks communicate through the third network.

2. The system of claim 1, wherein the first router of the third network is a hierarchical router of the first network, and the second router of the third network is a hierarchical router of the second network.

3. The system of claim 1, wherein:
a first router of the first network is reconfigured to serve as a hierarchical router for the first network by detachably coupling an external storage device to the first router, the external storage device containing data for reconfiguring only the first router of the first network to serve as the hierarchical router for the first network, and
a first router of the second network is reconfigured to serve as a hierarchical router for the second network by detachably coupling an external storage device to the first router of the second network, the external storage device containing data for reconfiguring only the first router of the second network to serve as the hierarchical router for the second network.

4. The system of claim 1, wherein:
a first router of the first network is configured to use a hierarchical router of the first network to communicate with a router of the second network by detachably coupling an external storage device to the first router of the first network, the external storage device containing data for reconfiguring only the first router of the first network to use the hierarchical router of the first network to communicate with a router of the second network, and
a first router of the second network is configured to use a hierarchical router of the second network to communicate with a router of the first network by detachably coupling an external storage device to the first router of the second network, the external storage device containing data for reconfiguring only the first router of the second network to use the hierarchical router of the second network to communicate with a router of the first network.

5. The system of claim 1, wherein a first router of the first network communicates with a first router of the second network only via a secure data path, the parameters of the secure data path provided by external storage devices that detachably couple to each router, wherein the storage devices defining the secure data paths are unique to each router.

6. The system of claim 1, wherein an encryption applied to the secure data path between each pair of routers is unique.

7. The system of claim 1, wherein no reconfiguration of a router in the first network is required when a router of the second network is reconfigured.

8. A method, comprising:
creating a third trust domain, the third trust domain comprising a hierarchical router of a first trust domain and a hierarchical router of a second trust domain, each router of the third trust domain configured by detachably coupling an external storage device to the router, each external storage device containing data for configuring only a single selected router; and
transferring data between the first and second trust domains via the third trust domain.

9. The method of claim 8, further comprising:
configuring a selected router of the first trust domain to serve as the hierarchical router for the first trust domain by detachably coupling an external storage device to the router, the external storage device containing data for configuring only the selected router to serve as the hierarchical router for the first trust domain; and
configuring a selected router of the second trust domain to serve as the hierarchical router for the second trust domain by detachably coupling an external storage device to the router, the external storage device containing data for configuring only the selected router to serve as the hierarchical router for the second trust domain.

10. The method of claim 8, further comprising:
creating the first trust domain, wherein each router of the first trust domain communicates only with each other router of the first trust domain via a secure data path; and
creating the second trust domain, wherein each router of the second trust domain communicates only with each other router of the second trust domain via a secure data path.

11. The method of claim 8, further comprising:
selecting a router of the first trust domain to serve as a hierarchical router for the first trust domain; and
selecting a router of the second trust domain to serve as a hierarchical router for the second trust domain.

12. The method of claim 8, further comprising:
configuring each router of the first trust domain to enable the hierarchical router for the first trust domain, each router of the first trust domain is configured by detachably coupling an external storage device to the router, each external storage device containing data for configuring only a single selected router; and
configuring each router of the second trust domain to enable the hierarchical router for the second trust domain, each router of the second trust domain is configured by detachably coupling an external storage device to the router, each external storage device containing data for configuring only a single selected router.

13. The method of claim 8, further comprising:
defining a set of configuration data comprising one or more attributes that when provided to a single selected router enable the router to serve as a hierarchical router for a trust domain; and
storing the configuration data in a storage device external to and capable of being detachably coupled to the selected router.

14. The method of claim 8, further comprising:
defining a set of configuration data comprising one or more attributes that when provided to a selected router of the first trust domain enable the first router to communicate with a router of the second trust domain through the hierarchical router of the first trust domain; and
storing the configuration data in a storage device external to and capable of being detachably coupled to the selected router.

15. A system, comprising:
a plurality of secure networks; and
a storage device comprising data for configuring a router of a first secure network to communicate with a router of a second secure network via a third secure network;
wherein the storage device is external to and capable of being detachably coupled to a router, and the data is applicable to only a single selected router.

16. The system of claim 15, wherein the data configures a single selected router of a secure network to serve as a hierarchical router for the network.

17. The system of claim 15, wherein the data configures a first router to recognize a second router as the hierarchical router for the network.

18. The system of claim 15, wherein the data configures a router for membership in the third secure network and one of the first secure network and the second secure network.

19. The system of claim 15, wherein the data is encrypted and no router other than the selected router is capable of decrypting the data.

20. The system of claim 15, wherein the data comprises user authorization data that identifies an individual permitted to use the storage device.
